(19) United States
(12) Patent Application Publication
(10) Pub. No.: US 2020/0207318 A1
(43) Pub. Date: Jul. 2, 2020

(54) BRAKE DRAGGING DETECTION AND MITIGATION

(71) Applicant: Caterpillar Inc., Deerfield, IL (US)

(72) Inventors: Ronald Paul DETTMAN, Burlington, CT (US); Lance COWPER, Metamora, IL (US); Nathaniel DOY, Maple Grove, MN (US)

(73) Assignee: Caterpillar Inc., Deerfield, IL (US)

(21) Appl. No.: 16/238,016

(22) Filed: Jan. 2, 2019

(51) Int. Cl. B60T 10/04; B60T 7/04

(52) U.S. Cl. CPC B60T 10/04; B60T 2220/04; B60T 2201/09; B60T 7/042

(57) ABSTRACT

A braking control device is disclosed. The braking control device may include one or more processors, communicatively coupled to one or more memories, to: determine a threshold for triggering a brake dragging event for a machine based on one or more parameters relating to activity of the machine; determine, based on a set of sensor measurements, that the threshold for triggering the brake dragging event is satisfied for a threshold quantity of time intervals; and perform a brake dragging response action based on determining that the threshold for triggering the brake dragging event is satisfied for the threshold quantity of time intervals.

### TECHNICAL FIELD

The present disclosure relates generally to a braking control device and, more particularly, to brake dragging detection and mitigation for brakes of a machine.

### BACKGROUND

A machine may include brakes coupled to a drivetrain to enable braking to slow the machine and/or stop the machine from moving. Use of the brakes may result in heat being transferred to powertrain oil of the machine, which may heat up hydraulic brake cooling oil, increase a temperature of the powertrain oil, and/or the like. The machine may use a coolant in connection with a fan system to reduce the temperature of the powertrain oil. Such a design may be included in many types of machines. For example, coolant may be used to reduce a temperature of powertrain oil, which is heated by braking in a vehicle, a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other equipment.

However, in a brake dragging scenario, an excess amount of heat may be transferred to the powertrain oil by brakes of the machine. A brake dragging scenario may be a scenario in which the machine is moving, but a small amount of braking is applied to the machine (e.g., an amount of braking is insufficient to stop the machine from moving). For example, when an operator inadvertently rests the operator's foot on a brake pedal while the machine is moving, a small amount of braking may occur, which may result in excess heat being transferred to the powertrain oil. Such excess heat may result in premature torque converter temperature warnings despite a lack of damage to a torque converter, which may result in unnecessary maintenance to the machine. Further, excess use of cooling fans to enable the coolant to cool the powertrain oil may result in excess power consumption by the machine, which may reduce range, result in excess utilization of battery or gasoline reserves, and/or the like.

One attempt to inform a driver of excessive braking is disclosed in Japanese Patent No. JPH1044976A that issued to Kishi et al. on Apr. 22, 2002 (“the '976 patent”). In particular, the '976 patent discloses “a temperature sensor for measuring the temperature of the brake of the tire.” While the “brake overheating alarm system” of '976 patent “generate[s] an alarm as a result of [a] comparison” of “the temperature of the brake [and] . . . a preset value,” the '976 patent does not address powertrain oil temperatures leading to unnecessary maintenance, excess power consumption, and/or the like. Moreover, the '976 patent fails to disclose detection of excessive braking when the excessive braking does not result in exceeding the preset value for the temperature of the brake, as may occur with brake dragging or other small amounts of braking.

The braking control system of the present disclosure solves one or more of the problems set forth above and/or other problems in the art.

### SUMMARY

According to some implementations, the present disclosure is related to a method that may include determining, by a braking control device of a machine, that a set of sensor measurements satisfies a corresponding set of measurement thresholds for a threshold period of time. The method may include determining, by the braking control device, that a brake dragging event is occurring based on determining that the set of sensor measurements satisfies the corresponding set of measurement thresholds for the threshold period of time. The method may include performing, by the braking control device, a brake dragging response action as a response to the brake dragging event based on determining that the brake dragging event is occurring.

According to some implementations, the present disclosure is related to a braking control device that may include one or more memories and one or more processors communicatively coupled to the one or more memories. The one or more processors may determine a threshold for triggering a brake dragging event for a machine based on one or more parameters relating to activity of the machine. The one or more processors may determine, based on a set of sensor measurements, that the threshold for triggering the brake dragging event is satisfied for a threshold quantity of time intervals. The one or more processors may perform a brake dragging response action based on determining that the threshold for triggering the brake dragging event is satisfied for the threshold quantity of time intervals.

According to some implementations, the present disclosure is related to a system that may include a lockout device to selectively lock out at least one functionality of a machine. The system may include a braking control device. The braking control device may be configured to receive a set of sensor measurements. The braking control device may be configured to determine, based on the set of sensor measurements, that a measurement threshold relating to a brake dragging event is satisfied for a threshold quantity of time intervals. The braking control device may be configured to provide an alert to indicate that the brake dragging event is occurring for the machine based on determining that the measurement threshold is satisfied. The braking control device may be configured to cause the lockout device to lock out the at least one functionality of the machine.

### BRIEF DESCRIPTION OF THE DRAWINGS

FIG. 1 is diagram of an example machine that includes a braking control system.

FIG. 2 is a diagram of an example environment in which systems and/or methods described herein may be implemented.

FIG. 3 is a flow chart of an example process for brake dragging detection and mitigation.

### DETAILED DESCRIPTION

This disclosure relates to a braking control device for brake dragging detection and mitigation. The braking control device has universal applicability to any machine utilizing such a brake dragging control device. Although some implementations described herein relate to a dozer, the implementations apply equally to other types of machines, such as vehicles, motor graders, tractors, or other above ground equipment, underground equipment, or marine equipment. Moreover, one or more implements may be connected to the machine and controlled by the braking control device.

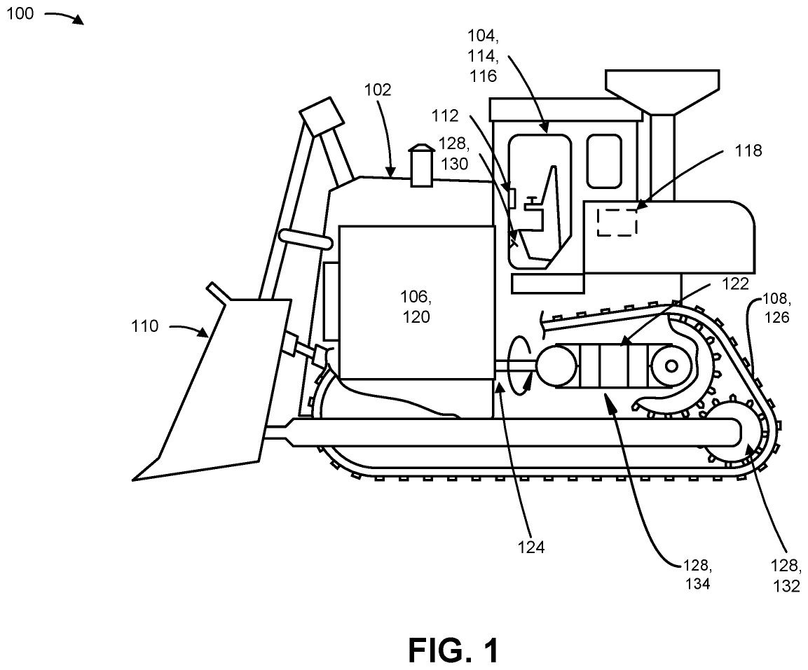

FIG. 1 is a diagram of an example machine 100 that includes a braking control device. The machine 100 is shown as a track type dozer but may include any type of machine that includes a braking control device capable of brake dragging detection and mitigation for the machine 100.

As shown, the machine 100 may have a frame 102 that supports an operator station 104, a power system 106, a drive system 108, and an implement 110. The operator station 104 may include operator controls 112 for operating the machine 100 via the power system 106. The illustrated operator station 104 is configured to define an interior cabin 114 within which the operator controls 112 are housed and which is accessible via a door 116.

The power system 106 is configured to supply power to the machine 100. The power system 106 may be operably arranged with the operator station 104 to receive control signals from the operator controls 112 in the operator station 104 and/or the braking control device 118. Additionally, or alternatively, the power system 106 may be operably arranged with the drive system 108 and/or the implement 110 to selectively operate the drive system 108 and/or the implement 110 according to the control signals received from the operator controls 112 and/or the braking control device 118.

The power system 106 may include an engine 120 and a transmission 122. The engine 120 may be any type of engine suitable for performing work using the machine 100, such as a diesel engine, a gasoline engine, a gaseous fuel-powered engine, an electric motor, and/or the like. The transmission 122 may transfer power from the engine to a drive shaft 124 and/or the implement 110. The transmission 122 may provide a number of gear ratios that enable the machine 100 to travel at a relatively wide range of speeds and/or conditions via the drive shaft 124, and/or that enable the use of the implement 110 to perform work.

The drive system 108 may be operably arranged with the power system 106 to selectively propel the machine 100 in accordance with control signals from the operator controls 112. The drive system 108 can include a plurality of ground-engaging members, such as tracks 126, as shown, which can be movably connected to the frame 102 through axles, drive shafts, gears, and/or other components. In some implementations, the drive system 108 may be provided in the form of a wheel-drive system or any other type of drive system configured to propel the machine 100.

The implement 110 may be operably arranged with the power system 106 such that the implement 110 is movable through control signals transmitted from the operator controls 112. The illustrated implement 110 is a blade. Other embodiments can include any other suitable implement for a variety of tasks, including, for example, ripping, dozing, grading, and/or the like. Example implements include rippers, loaders, grader bits and end bits, and/or the like.

The braking control device 118 may be communicatively coupled to one or more sensors 128. For example, a brake pedal travel sensor may be communicatively coupled to the braking control device 118 to provide information identifying a brake pedal depression of brake pedal 130. Similarly, a temperature sensor may be communicatively coupled to the braking control device 118 to provide information identifying a brake temperature of brakes 132, a powertrain oil temperature for powertrain oil of powertrain 134, and/or the like. A braking system that includes brakes 132 may be cooled using a coolant of a powertrain system that includes powertrain 134.

As indicated above, FIG. 1 is provided as an example. Other examples may differ from what is described in connection with FIG. 1.

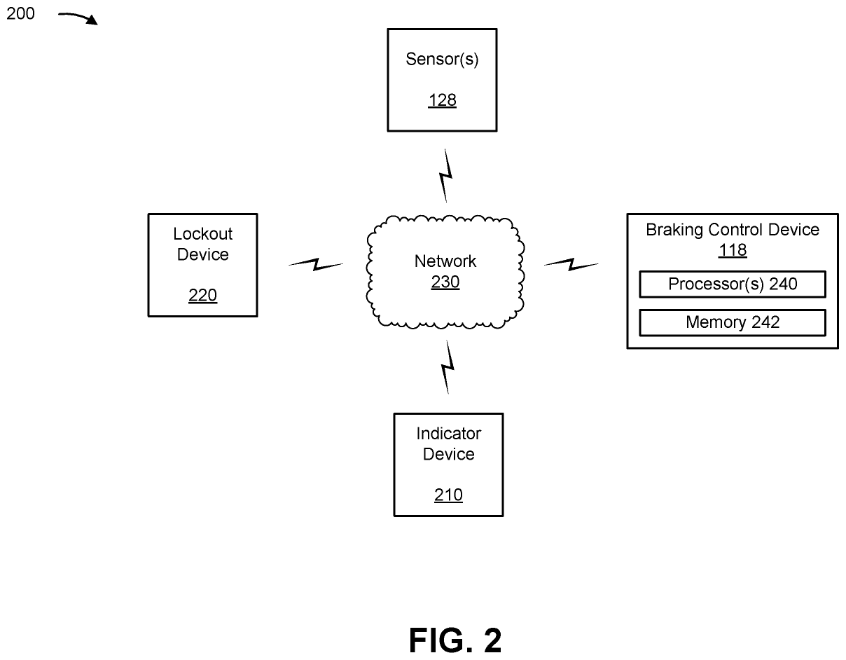

FIG. 2 is a diagram of an example environment 200 in which systems and/or methods described herein may be implemented. As shown in FIG. 2, environment 200 may include a braking control device 118, a sensor 128, an indicator device 210, a lockout device 220, and a network 230. Devices of environment 200 may interconnect via wired connections, wireless connections, or a combination of wired and wireless connections.

The braking control device 118 includes one or more processors 240 (e.g., a microprocessor, a microcontroller, a field-programmable gate array (FPGA), an application-specific integrated circuit (ASIC), and/or the like) and a memory 242 (e.g., read-only memory (ROM), random-access memory (RAM), and/or the like). In some implementations, the braking control device 118 may be an electronic control unit, an engine control unit, and/or the like of the machine 100. The processor 240 may execute one or more instructions and/or commands to control one or more components of the machine 100, such as to automatically detect a brake dragging event and provide an indication that the brake dragging event is occurring. The memory 242 may store program code for execution by the processor 240 and/or for storing data in connection with execution of such program code by the processor 240.

The braking control device 118 may receive one or more input signals from various components of the machine 100, may operate on the one or more input signals to generate one or more output signals (e.g., by executing a program using the input signals as input to the program), and may output the one or more output signals to various components of the machine 100. For example, the braking control device 118 may receive a set of sensor measurements, such as a brake pedal travel measurement, an engine speed measurement, a transmission gear measurement (e.g., whether the transmission 122 is in gear or not in gear, which gear the transmission 122 is in, etc.), a brake energy consumption measurement, a brake temperature measurement, a powertrain oil temperature measurement, a location determination, a road grade measurement, and/or the like. In this case, the braking control device 118 may determine that the set of sensor measurements satisfies a set of measurement thresholds during a set of time intervals, and may perform a response action to mitigate a brake dragging event (e.g., by providing an output signal to the indicator device 210, the lockout device 220, and/or the like).

Sensors 128 include a set of sensor devices that provide information regarding a status of the machine 100. For example, the sensors 128 may include a brake pedal sensor (e.g., to detect a brake pedal travel), an engine speed sensor, a transmission gear sensor, a brake temperature sensor, a brake energy consumption sensor, a powertrain oil sensor, a grade sensor, a location determination module, a heat sensor, a fan speed sensor, and/or the like. For example, the brake pedal travel sensor may provide output based on which the braking control device 118 may determine that a brake dragging event is occurring. In this case, based, for example, on the brake pedal travel satisfying a threshold, the braking control device 118 may provide an indication using indicator device 210, adjust a brake pedal calibration, lock out use of the implement 110 using the lockout device 220, and/or the like.

Lockout device 220 includes a control device (e.g., a controller, an actuator, and/or the like) that controls components of the machine 100. For example, the lockout device 220 may control the implement 110, the engine 120, the transmission 122, and/or the like. In some implementations, the lockout device 220 may include a forward gear limiter, a machine speed limiter, a reverse gear lockout, a grader lockout, an articulation lower lockout, an automatic differential lockout, a threshold forward gear lockout, and/or the like.

Indicator device 210 includes a communication device to provide information regarding a status of the machine 100. For example, the indicator device 210 may be a set of light emitting diodes associated with the operator controls 112 and/or the operator station 104 to provide information indicating whether a brake dragging event is occurring, whether the lockout device 220 is activated to lockout a particular function, and/or the like. Additionally, or alternatively, the indicator device 210 may be a device providing a user interface for the machine 100 that provides information regarding a status of one or more functions, that provides one or more alerts, and/or the like.

Network 230 includes one or more wired and/or wireless networks. For example, the network 230 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a controller area network (CAN), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

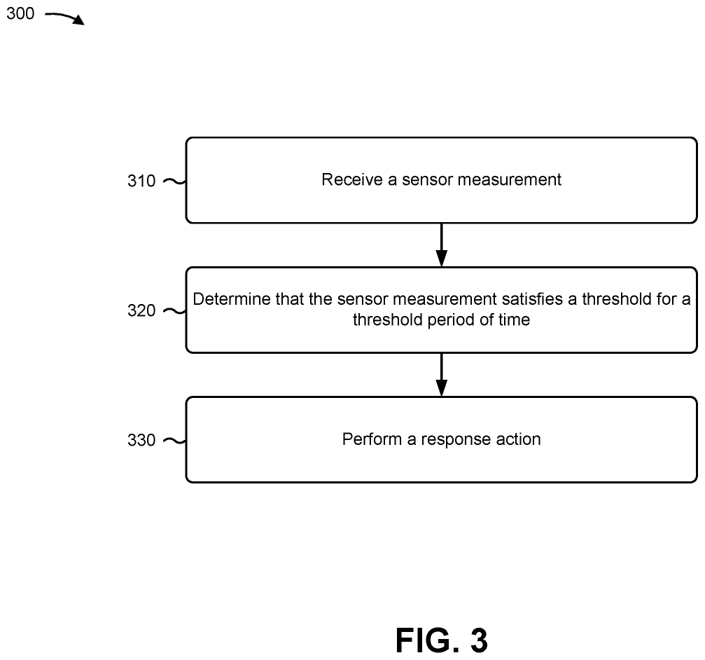

FIG. 3 is a flow chart of an example process 300 for brake dragging detection and mitigation. In some implementations, one or more process blocks of FIG. 3 may be performed by a braking control device (e.g., the braking control device 118). In some implementations, one or more process blocks of FIG. 3 may be performed by another device or a group of devices separate from or including a braking control device (e.g., the braking control device 118), such as a sensor (e.g., sensor(s) 128), an indicator device (e.g., indicator device 210), and a lockout device (e.g., lockout device 220).

As shown in FIG. 3, process 300 may include receiving a sensor measurement (block 310). For example, the braking control device (e.g., using processor(s) 240, memory 242, and/or the like) may receive the sensor measurement. In some implementations, the braking control device may receive multiple sensor measurements. For example, the braking control device may receive information identifying a brake pedal travel (e.g., a percentage of a maximum brake pedal travel), an engine speed, a transmission gear, an engine load (e.g., a ratio of actual torque to available torque, a ratio of actual fuel use to available fuel, and/or the like), and/or the like from one or more sensors.

As shown in FIG. 3, process 300 may include determining that the sensor measurement satisfies a threshold for a threshold period of time (block 320). For example, the braking control device (e.g., using processor(s) 240, memory 242, and/or the like) may determine that the sensor measurement satisfies the threshold for the threshold period of time. In some implementations, the braking control device may determine the threshold based on stored information. For example, the braking control device may store information indicating that a brake pedal travel greater than a threshold (e.g., greater than 1%, 5%, 10%, etc. of a full brake pedal travel range) is to trigger detection of a brake dragging event. In this case, the braking control device may determine that the sensor measurement (e.g., a brake pedal travel of 20%) satisfies the threshold (e.g., a threshold of 10%) for a threshold period of time (e.g., 10 seconds). Additionally, or alternatively, the braking control device may determine a range of values for detecting a brake dragging event. For example, the braking control device may determine that a brake pedal travel value in a range of brake pedal travel values of between 0% and 10% satisfy a threshold, and that a higher brake pedal travel value indicates an attempt to stop a machine rather than a brake dragging event.

Additionally, or alternatively, the braking control device may determine a threshold for a first measurement based on a second measurement value. For example, the braking control device may determine that a brake pedal travel threshold (e.g., for detecting a brake dragging event) is a first value (e.g., 1%) when a powertrain oil temperature is a first value (e.g., 150 degrees Celsius (C)), and that the brake pedal travel threshold is a second value (e.g., 5%) when the powertrain oil temperature is a second value (e.g., 100 degrees C.). Similarly, based on stored information identifying an average brake pedal travel for an operator of a machine, the braking control device may determine that a brake pedal travel threshold is a first value for a first operator and a second value for a second operator.

In some implementations, the braking control device may determine that the sensor measurement satisfies the threshold for a single threshold period of time. For example, the braking control device may determine that the brake pedal travel satisfies a brake pedal travel threshold for a single 5 second period, and may determine that a brake dragging event is occurring. Additionally, or alternatively, the braking control device may determine that the sensor measurement satisfies the threshold during a threshold quantity of time intervals. For example, the braking control device may detect a brake dragging event when the brake pedal travel threshold is satisfied for an entirety of a set of multiple consecutive time intervals (for an entirety of four 5 second time intervals in a row); for a portion of a set of multiple consecutive time intervals (e.g., for at least a portion of each 5 second time interval of a set of four 5 second time intervals); for a particular quantity of time intervals in a set of multiple consecutive time intervals (e.g., for three time intervals out of four consecutive time intervals); and/or the like. In this way, the braking control device may filter out a transient brake dragging event for which mitigation is not necessary, and may detect a non-transient brake dragging event for which mitigation is to be performed.

As shown in FIG. 3, process 300 may include performing a response action (block 330). For example, the braking control device (e.g., using processor(s) 240, memory 242, and/or the like) may perform the response action. In some implementations, the braking control device may provide a notification. For example, the braking control device may cause an indicator device to provide an indication, such as activating an indicator light or making an audio alert to alert an operator regarding the brake dragging event. Additionally, or alternatively, the braking control device may recalibrate a brake pedal to cause, for example, a 5% brake pedal travel to be reset to be a 0% brake pedal travel, as explained in more detail below. Additionally, or alternatively, the braking control device may cause a lockout device to lock out a functionality of a machine, such as limiting a gear of a transmission, preventing an implement from being articulated, and/or the like. In some implementations, the braking control device may store an indication of the brake dragging event in a log file for use in diagnostics of the machine, evaluation of an operator of the machine, and/or the like.

Process 300 may include additional implementations, such as any single implementation or any combination of implementations described herein.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

The braking control device 118 may be used with any machine 100 that permits an operator to interact with operator controls 112 to drive the machine 100. During operation of machine 100, the braking control device 118 automatically detects a brake dragging event, such as when an operator inadvertently or intentionally depresses a brake pedal during motion of the machine 100. In this case, the braking control device 118 detects the brake dragging event based on sensor measurements, such as of a brake pedal travel, a speed of the machine 100, a gear of the machine 100, and/or the like, and performs a response action. In some implementations, the response action may include the braking control device 118 causing an alert to be provided to the operator. Additionally, or alternatively, the braking control device 118 may recalibrate a brake pedal of the machine 100 to cause a detected brake travel to be recalibrated as a zero brake travel. In other words, if an operator causes brake dragging by inadvertently depressing a brake pedal 5% to rest the operator's foot, the brake pedal may be recalibrated such that a brake pedal travel of between 0% and 5% does not cause braking of the machine 100, thereby avoiding brake dragging while enabling the operator to continue resting a foot on the brake pedal.

In this way, by alerting the operator, recalibrating the brake pedal, and/or the like, the operator may stop causing braking, which may stop the brake dragging event and avoid causing excess heating of powertrain oil of a powertrain of the machine 100 (e.g., which may be used to cool brakes of the machine 100). In this case, by avoiding causing excess heating of the powertrain oil and/or by reducing a temperature of the powertrain oil (e.g., relative to a current powertrain oil temperature), the braking control device 118 may reduce inefficiency of the machine 100. For example, the braking control device 118 may reduce an engine fan power or an engine fan speed (e.g., relative to a current engine fan power or engine fan speed) used to cool the powertrain oil, which may reduce wasting of fuel to power a fan.

Additionally, or alternatively, the braking control device 118 may alter another parameter of the machine 100 based on detecting a brake dragging event. For example, the braking control device 118 may lockout a transmission of the machine 100 to avoid the machine 100 shifting to a higher gear, thereby avoiding the machine 100 traveling at excess speed during the brake dragging event, which may reduce an effect of brake dragging. Additionally, or alternatively, the braking control device 118 may automatically reduce an engine power output, automatically stop applying braking, automatically adjust a fan speed, and/or the like to obviate an effect of brake dragging on the machine 100.

The foregoing disclosure provides illustration and description, but is not intended to be exhaustive or to limit the implementations to the precise form disclosed.

What is claimed is:

1. A method, comprising:
determining, by a braking control device of a machine, that a set of sensor measurements satisfies a corresponding set of measurement thresholds for a threshold period of time; and
determining, by the braking control device, that a brake dragging event is occurring based on determining that the set of sensor measurements satisfies the corresponding set of measurement thresholds for the threshold period of time; and
performing, by the braking control device, a brake dragging response action as a response to the brake dragging event based on determining that the brake dragging event is occurring.

2. The method of claim 1, further comprising:
receiving the set of sensor measurements; and
wherein determining that the set of sensor measurements satisfies the corresponding set of measurement thresholds comprises:
determining that the set of sensor measurements satisfies the corresponding set of measurement thresholds based on receiving the set of sensor measurements.

3. The method of claim 1, wherein the set of sensor measurements includes at least one of:
a brake pedal travel measurement,
an engine speed measurement,
a transmission gear measurement,
an engine load measurement,
a brake energy consumption measurement, or
a powertrain oil temperature measurement.

4. The method of claim 1, wherein performing the brake dragging response action comprises:
providing an alert indicating that the brake dragging event is occurring.

5. The method of claim 1, wherein performing the brake dragging response action comprises:
locking out a functionality of the machine.

6. The method of claim 1, wherein performing the brake dragging response action comprises:
reducing an engine power of an engine of the machine.

7. The method of claim 1, wherein performing the brake dragging response action comprises:
rescaling a brake pedal sensor.

8. A braking control device, comprising:
one or more memories; and
one or more processors, communicatively coupled to the one or more memories, to:
determine a threshold for triggering a brake dragging event for a machine based on one or more parameters relating to activity of the machine;
determine, based on a set of sensor measurements, that the threshold for triggering the brake dragging event is satisfied for a threshold quantity of time intervals; and
perform a brake dragging response action based on determining that the threshold for triggering the brake dragging event is satisfied for the threshold quantity of time intervals.

9. The braking control device of claim 8, wherein the one or more processors, when performing the brake dragging response action, are to:
alter one or more parameters of the machine to reduce a powertrain oil temperature relative to a current powertrain oil temperature.

10. The braking control device of claim 8, wherein the one or more processors, when performing the brake dragging response action, are to:
alter one or more parameters of the machine to reduce an engine fan speed relative to a current engine fan speed.

11. The braking control device of claim 8, wherein the threshold for triggering the brake dragging event is a range of brake pedal travel values.

12. The braking control device of claim 11, wherein the range of brake pedal travel values is greater than zero and less than YYYY percent of a full brake pedal travel range.

13. The braking control device of claim 8, wherein the one or more processors, when performing the brake dragging response action, are to:
cause an audio or visual alert to be provided.

14. The braking control device of claim 8, wherein the threshold for triggering the brake dragging event or the threshold quantity of time intervals is configurable based on information identifying an operator of the machine.

15. A system comprising:
a lockout device to selectively lock out at least one functionality of a machine;
a braking control device configured to:
receive a set of sensor measurements;
determine, based on the set of sensor measurements, that a measurement threshold relating to a brake dragging event is satisfied for a threshold quantity of time intervals;
provide an alert to indicate that the brake dragging event is occurring for the machine based on determining that the measurement threshold is satisfied; and
cause the lockout device to lock out the at least one functionality of the machine.

16. The system of claim 15, wherein the braking control device is further configured to:
determine that the brake dragging event is occurring based on determining that the measurement threshold relating to the brake dragging event is satisfied for the threshold quantity of time intervals; and
store information identifying the brake dragging event in a log file associated with the machine or an operator of the machine.

17. The system of claim 15, further comprising:
at least one sensor to provide the set of sensor measurements.

18. The system of claim 17, wherein the at least one sensor includes at least one of:
a brake pedal travel sensor,
an engine speed sensor,
a transmission gear sensor,
a heat sensor, or
a fan speed sensor.

19. The system of claim 15, wherein the machine is one of: a tractor, a vehicle, a dozer, or a motor grader.

20. The system of claim 15, wherein a braking system of the machine is cooled using a coolant of a powertrain system of the machine.
